(19) United States
(12) Patent Application Publication
(10) Pub. No.: US 2015/0291404 A1
(43) Pub. Date: Oct. 15, 2015

(54) WALKWAY WITH HYDRAULIC LIFTING FOR AREAS SUBJECT TO FLOODING

(71) Applicants: Marco BIAVA, ALZANO LOMBARDO (BG) (IT); Felice Zini, Chiari (BS) (IT)

(72) Inventors: Marco BIAVA, ALZANO LOMBARDO (BG) (IT); Felice Zini, Chiari (BS) (IT)

(21) Appl. No.: 14/685,952

(22) Filed: Apr. 14, 2015

(30) Foreign Application Priority Data
Apr. 15, 2014 (IT) BG2014A000011

(51) Int. Cl. B66F 7/20

(52) U.S. Cl. CPC B66F 7/20

(57) ABSTRACT

A walkway with hydraulic lifting for areas subject to flooding comprising: a base (11); a horizontal walking surface (15) arranged on top of said base (11); and lifting means (20) to lift said walking surface (15) and move it away from said base (11); characterized in that said lifting means (20) comprise at least one telescopic cylinder (20) operable upon command by means of water at a pressure of between 3 and 8 bar; and said walking surface (15) rests on said telescopic cylinder (20). (FIG. 2)

The present invention refers to a walkway with hydraulic lifting for areas subject to flooding.

In particular, it refers to a walkway for creating paths rising out of the water in flooded areas, by placing them side by side to each other.

A walkway according to the present invention is particularly useful in cases where there is periodic flooding and it is necessary to provide a dry pathway for pedestrians, such as in the case of high water in Venice, for example.

In fact, during periods of high water in Venice, wooden walkways resting on trestles are positioned to allow passage in points blocked by water, in order to provide access to a large part of the city.

The drawback of these walkways is that they must be promptly positioned in situ by teams of workers and removed to a storage area when not in use.

This is a large amount of work to be carried out, with great expense in terms of human resources.

The object of the present invention is to provide a walkway with hydraulic lifting that resolves the drawbacks of the known art.

Another object is to provide a walkway that can resist in a marine and/or brackish environment without problems.

A further object is to provide a walkway that does not need to be placed in situ in the event of flooding and subsequently has to be removed.

According to the present invention, these objects, and still others, are achieved by a walkway with hydraulic lifting for areas subject to flooding according to claim 1.

Further characteristics of the invention are described in the dependent claims.

There are several advantages of this solution with respect to solutions of the known art.

The walkway according to the present invention is simple to produce, robust and does not require electricity for operation.

By being made entirely of stainless steel of suitable quality, it is unaffected by humidity and salinity.

It is operated using fresh water, but can also use sea water, and no oil or other polluting fluid is used in either case.

When lowered, it is practically invisible, as it can be covered with the same paving used in the area where the walkway has been positioned and so it does not create architectonic problems.

In a short time, just one person can activate a considerable number of walkways.

The characteristics and advantages of the present invention will become evident from the following detailed description of a practical embodiment, shown by way of non-limitative example in the accompanying drawings, where:

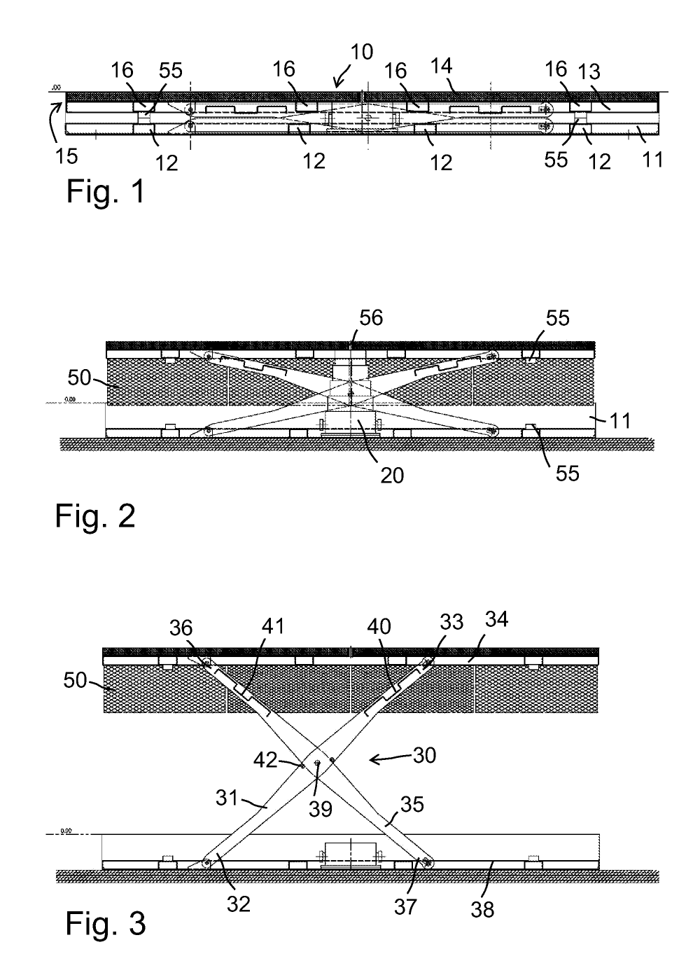

FIG. 1 shows a walkway lowered in the rest position, seen from the side and in cross-section, according to the present invention;

FIG. 2 shows a walkway raised in the working position, seen from the side and in cross-section, according to the present invention;

FIG. 3 shows a walkway raised in the maintenance position, seen from the side and in cross-section, according to the present invention;

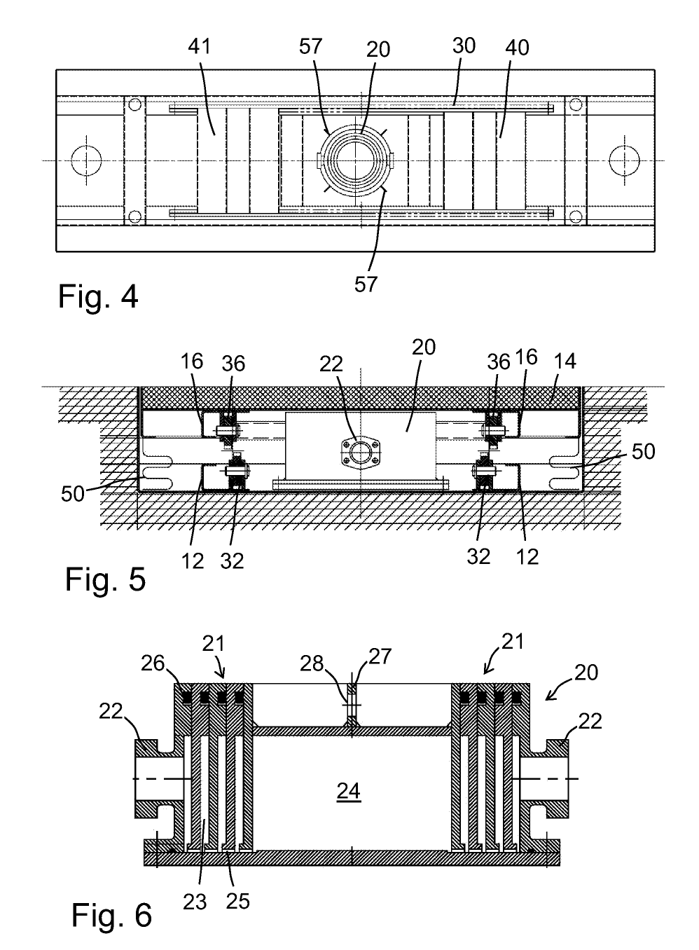

FIG. 4 shows a walkway, seen from above and partially transparent, according to the present invention;

FIG. 5 shows a walkway closed in the rest position, seen from the front and in cross-section, according to the present invention;

FIG. 6 shows a telescopic cylinder to lift a walkway, seen from the side and in cross-section, according to the present invention;

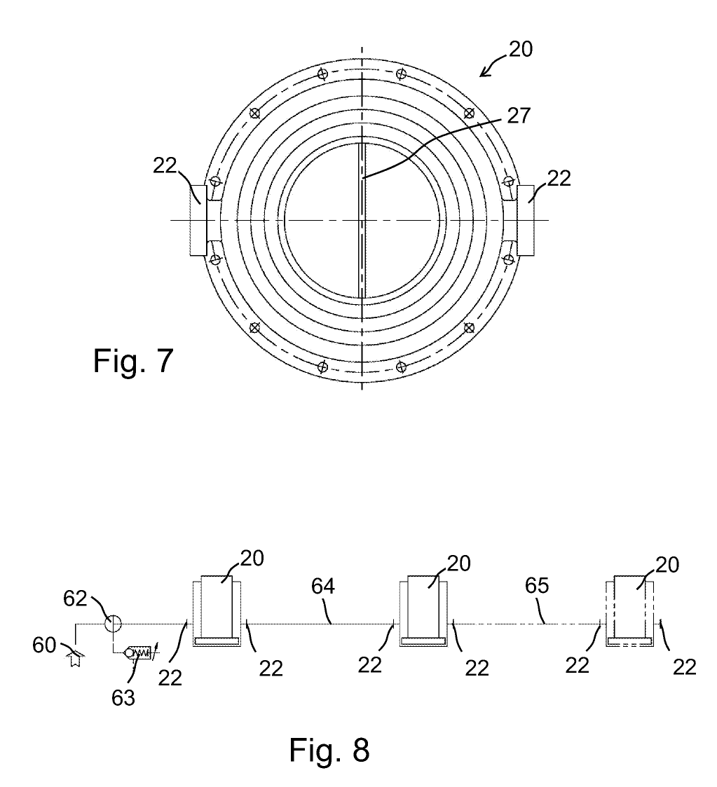

FIG. 7 shows a telescopic cylinder to lift a walkway, seen from above, according to the present invention; and

FIG. 8 schematically shows a system of a plurality of walkways, according to the present invention.

With reference to the accompanying figures, a walkway 10 with hydraulic lifting for areas subject to flooding, according to the present invention, comprises a base 11 preferably composed of a casing open at the top and typically having dimensions of 4000×1200×290 mm.

The base 11 is designed to be laid on the ground inside a trench typically 290 mm deep, and so the base 11 is completely buried.

The base 11 is preferably reinforced with cross-beams 12.

The walkway 10 comprises a lower, first casing 13, similar to the base 11 but overturned, i.e. open at the bottom, over which an upper, second casing 14, open at the top, is placed and fastened.

The first casing 13 and the second casing 14 form a horizontal walking surface 15.

The first casing 13 is preferably reinforced with cross-beams 16.

The second casing 14 is filled with surrounding paving material.

The walking surface 15 is positioned and aligned over the base 11.

The walkway 10 comprises a telescopic cylinder 20 for raising the walking surface 15.

In the embodiment shown, the telescopic cylinder 20 is composed of five concentric elements 21 having decreasing diameters towards the centre of the cylinder and sliding one within the other.

Two flanges 22 are located on the side of the cylinder 20, one opposite the other, for connection to the piping of the fluid for operating the telescopic cylinder 20, typically water.

Between each element 21 and an adjacent one there is a closed circular chamber 23 created by a reduction in the thickness of each the elements 21.

The innermost element 21 has an inner cylindrical chamber 24.

In the lower part of each of the elements 21 there is a passage 25 that each one of the chambers 23 in communication with chamber 24.

In the upper part of each of the elements 21 there is an O-ring 26 for sealing the control fluid.

Above the chamber 24 of the innermost element 21 there is a vertical plate 27 with a hole 28 for lifting the telescopic cylinder 20, in the event of maintenance.

The telescopic cylinder 20 rests on the base 11 and can be fastened to it by bolts or, more preferably, can be positioned without being fastened, in an seat suitable for preventing its movement and delimitated, for example, by four stops 57 welded on the bottom of the base 11.

When the cylinder 20 is operated, the upper surface of the innermost element 21 presses on the first casing 13 and raises the walking surface 15.

The telescopic cylinder 20 has a rest height of 200 mm and an extended height of 700 mm.

Two pairs of scissor-connected arms 30 are provided to guide the lifting and give stability to the walking surface 15.

Each of the pairs of arms 30 comprises a first arm 31 having a lower, first end 32, rotatably engaged on the base 11 and an upper, second end 33, sliding horizontally in a guide 34 located on the first casing 13.

A second arm 35 is also comprised, having an upper, first end 36, rotatably engaged on the first casing 13 and a lower, second end 37, sliding horizontally in a guide 38 located on the base 11.

The first arm 31 and the second arm 35 are rotatably engaged to each other by a pivot 39 located approximately halfway along the length of arms 31 and 35.

To provide greater stability to the structure, the pairs of arms 30 are connected to each other by a first section bar 40 that connects the first arms 31 and a section bar 41 that connects the second arms 35. The connections are made on the upper half-arms.

In the rest position, the movable part 15 of the walkway 10 rests on four feet 55 positioned close to the corners of the platform so as to make the structure more resistant and allow the transit of much heavier loads than those deriving from the passage of pedestrians, without damage to the elements of the walkway.

Nets 50 are fastened laterally (along the longer sides) and below the first casing 13, these being folded with the walkway 10 in the rest position (closed) and spread out with the walkway 10 in the working position (open) to laterally cover the space left open at the sides of the structure.

The nets 50 are made of stainless steel wire with a mesh size, for example, of 1 or 2 cm. These nets are such that they can fold when the walkway is closed and spread out when the walkway is open.

The nets 50 have been provided to avoid floating objects from finding their way inside the structure of the walkway 10 and causing possible malfunction.

To create paths rising out of the water in flooded areas, a plurality of walkways 10 are placed side by side along their short sides. Once the number of side-by-side walkways controlled by a single control is defined, the telescopic cylinders 20 are connected to the piping of an operating fluid.

In particular, a water inlet pipe 60, at a pressure of 5 bar for example, and in any case between 3 and 8 bar, a pressure obtained by opportune pumps, is connected to a first way of a manually or automatically controlled three-way supply valve 62.

A second way of the valve 62 is connected to a check valve 62, set to a pressure of 1 bar for example, and used for discharging the water.

The third way of the valve 62 is connected to the first flange 22 of the first cylinder 20, the second flange 22 of the first cylinder 20 is connected to piping 64 that connects to the first flange 22 of the second cylinder 20, the second flange 22 of the second cylinder 20 is connected to piping 65 that connects to the first flange 22 of the third cylinder 20, and the second flange 22 of the third and last cylinder 20 is sealed with a plug.

The functioning of the present invention shall be clear to a person skilled in the art from what has been described and which, in particular, is as follows.

In the rest position, the walkway 10 is completely hidden in the trench prepared for it and for the adjacent walkways. The second casing 14 is filled with paving material of the same type as that already present and so the presence of the walkway is practically unnoticeable.

When high water arrives, the operator manually or automatically opens valve 62 to raise the walkways connected to it.

Upon installation of the walkways and hence the first lifting operation and consequent discharge of the water through valve 63, the latter being set, for example, to 1 bar, water remains inside so that air bubbles do not form that might compromise subsequent operations. Always in the installation phase, all air bubbles inside the system are eliminated by means of known expedients.

Water under pressure, for example 5 bar, enters from the first flange 22 of the first cylinder 20, enters the chambers 23 and passes in the passages 25.

Part of the water comes out from the second flange 22 and passes to the second cylinder 20.

The cylinders 20, connected to the same valve 62, extend and push the casing 13, raising the walking surface 15 until the cylinders 20 have been fully extended. The respective walkways are raised, creating a pedestrian passageway raised above road level, by 500 mm in the proposed example.

In maintaining the water pressure (5 bar) and size of the cylinder, a force of approximately 2500 Kg is exerted, capable of sustaining the walkway and the people who might walk over it.

When flooding ceases, the operator closes valve 62 and, as there is no longer any input pressure, the water can automatically drain through valve 63.

In the case of maintenance on the walkways, it is possible to lift the walking surface 15 by means of opportune lifting machines to a height of 1500 mm. A coupling point 56 is provided on the walking surface 15 for this purpose.

For total work safety, the walkway can be blocked in the maintenance position by a latch 42 to prevent accidental descent.

The arms 31 and 35 follow the lifting as the guides 34 and 38 have been designed with a such a length to be able to perform this operation. Since the walking surface 15 is lifted up, the operator can access the inside of the walkway to carry out the required operations.

During maintenance operations, as the telescopic cylinder 20 has not been operated, it remains in its retracted rest position; it is possible to hitch it by means of the hole 28 and lift it for any maintenance work.

The walkways can be of any size, according to requirements and the state of the art.

The thus conceived system is susceptible of numerous modifications and variants, all falling within the scope of the invention; furthermore, all of the details can be replaced by technically equivalent elements.

1. A walkway with hydraulic lifting for areas subject to flooding comprising:
a base (11); a horizontal walking surface (15) arranged on top of said base (11); lifting means (20) to lift said walking surface (15) and move it away from said base (11); said lifting means (20) comprise at least one telescopic cylinder (20) operable upon command by means of water at a pressure of between 3 and 8 bar; and said walking surface (15) rests on said telescopic cylinder (20); characterized in that it comprises two pairs of scissor-connected arms (30), which connect said base (11) to said walking surface (15).

2. A walkway according to claim 1 characterized in that said base (11) is constituted by a buried casing, open at the top.

3. A walkway according to claim 1, characterized in that said walking surface (15) comprises a surface (14) having paving material on the upper part.

4. A walkway according to claim 1, characterized in that said walking surface (15) comprises a first casing (13), open at the bottom, on top of which a second casing (14), open at the top, is placed.

5. A walkway according to claim 1, characterized in that said telescopic cylinder (20) comprises a plurality of concentric elements (21) having decreasing diameters towards the centre of the telescopic cylinder (20) and sliding one inside the other; between each element (21) and an adjacent one there is a closed circular chamber (23); in each of the elements (21) there is a passage (25) that places each of the chambers (23) in communication; and at least one opening (22) is located on the side of the outermost element (21).

6. A walkway according to claim 1, characterized in that it comprises: a first arm (31) having a lower, first end (32), rotatably engaged on said base (11) and an upper, second end (33), horizontally sliding in a guide (34) located on the first casing (13); a second arm (35) having an upper, first end (36), rotatably engaged on the first casing (13) and a lower, second end (37), horizontally sliding in a guide (38) located on said base (11); said first arm (31) and said second arm (35) are rotatably engaged to each other by a pivot (39) located approximately halfway along the length of said first (31) and second (35) arms.

7. A walkway according to claim 1, characterized in that it comprises a first and a second flexible net (50) located laterally and fastened to said walking surface (15).

8. A walkway according to claim 1, characterized in that it comprises fluid inlet and discharge means connected to said lifting means (20).

9. A walkway according to claim 1, characterized in that said telescopic cylinder (20) comprises two flanges (22), one opposite the other, for the connection of a control fluid of said telescopic cylinder (20).

10. A walkway with hydraulic lifting for areas subject to flooding comprising: a base (11); a horizontal walking surface (15) arranged on top of said base (11); a lift (20) to lift said walking surface (15) and move it away from said base (11); said lift (20) comprising at least one telescopic cylinder (20) operable upon command by water at a pressure of between 3 and 8 bar;
said walking surface (15) resting on said telescopic cylinder (20); characterized by two pairs of scissor-connected arms (30), which connect said base (11) to said walking surface (15).
